(19) United States
(12) Patent Application Publication
(10) Pub. No.: US 2018/0217845 A1
(43) Pub. Date: Aug. 2, 2018

(54) CODE GENERATION APPARATUS AND CODE GENERATION METHOD

(71) Applicant: FUJITSU LIMITED, Kawasaki-shi (JP)

(72) Inventor: Shigeru KIMURA, Hachiouji (JP)

(73) Assignee: FUJITSU LIMITED, Kawasaki-shi (JP)

(21) Appl. No.: 15/878,781

(22) Filed: Jan. 24, 2018

(30) Foreign Application Priority Data
Feb. 2, 2017 (JP) 2017-017782

(51) Int. Cl. G06F 9/38; G06F 15/80; G06F 9/30

(52) U.S. Cl. CPC G06F 9/3887; G06F 15/8007; G06F 9/30065; G06F 9/3001; G06F 9/30018

(57) ABSTRACT

An apparatus includes a processor configured to execute a process of generating a second program according to a first program, the second program including: a first process in which an operation according to a first operation instruction is performed on operation elements iteratively; a second process in which a mask bit string including as mask bits as the number of operand elements is set; and a third process in which the operation is performed on as respective elements as the number of operand elements according to second operation instruction, the elements including one or more remainder operation elements not subjected to the operation in the first process and one or more non-operation elements excluded from being operated on as the number of operand elements, the operation according to the second operation instruction being performed.

### CROSS-REFERENCE TO RELATED APPLICATION

This application is based upon and claims the benefit of priority of the prior Japanese Patent Application No. 2017-017782, filed on Feb. 2, 2017, the entire contents of which are incorporated herein by reference.

### FIELD

The embodiments discussed herein are related to a code generation apparatus and code generation method.

### BACKGROUND

Many modern processors are capable of executing Single Instruction Multiple Data (SIMD) instructions. A SIMD instruction instructs it to execute the same operation on a plurality of pieces of data in parallel. Hereinafter, an operand of a SIMD instruction, that is, each piece of data that is operated on by the SIMD instruction will be referred to as an “element”. The data length of each element operated on by the SIMD instruction will be referred to as a “SIMD width”.

For example, when a processor reads out an instruction, if the instruction is a SIMD instruction, the processor extracts a plurality of elements whose total data size corresponds to a capacity of a register for use in handing a SIMD instruction (hereinafter, referred to as a “SIMD register”, and the processor stores the extracted elements in the SIMD register. The number of elements allowed to be stored in one SIMD register is referred to as the “number of SIMD elements”. The processor executes the same operation on the respective elements in the SIMD register in parallel. The processor then stores an operation result in units of elements in a memory.

In a case where the same operation is executed on a plurality of respective elements, use of such a SIMD instruction makes it possible to execute the operation on as many elements as the number of SIMD elements in parallel by one execution of the SIMD instruction. This allows an increase in operation performance compared with the case in which the same operation is performed on the plurality of elements such that the operation is performed on one element at a time and the operation is repeated to handle the elements on an element-by-element basis.

As one of operation speed-up techniques, for example, it is known to replace a DO loop, in which the same operation is repeated according to an IF-THEN-ELSE statement, by one operation with no mask. There is also a known technique that makes it possible to execute a vector operation even for a program including multiply nested IF statements. Furthermore, there is also a known technique in which in a case where a data string to be subjected to a SIMD algorithm operation is a part of a long continuous data string extending into an outer loop, a conversion to SIMD instructions is performed taking into account the outer loop such that a SIMD code having no fraction is generated.

Descriptions of related techniques may be found, for example, in Japanese Laid-open Patent Publication No. 5-120323, Japanese Laid-open Patent Publication No. 7-56892, and Japanese Laid-open Patent Publication No. 2009-265708.

In a case where the number of iterations of an original non-SIMD iterative process (the number of iterations of the loop) is equal to a multiple of the number of SIMD elements, a processor that supports SIMD instructions can efficiently perform an operation on all elements using SIMD instructions. However, in a case where the number of iterations of the loop is not equal to a multiple of the number of SIMD elements, a smaller number of elements (fraction) than the number of SIMD elements finally remains without being processed after an iteration of an operation using a SIMD instruction by the processor is completed. In the SIMD instruction, the operation is performed concurrently for as many elements as the number of SIMD elements, and thus, if the SIMD instruction is applied to fractional elements, the result is that the elements that are not to be subjected to the operation are also subjected to the operation. The execution of such an unnecessary operation on elements that are not to be subjected to the operation may cause a program to have a bug.

To handle the above situation, in conventional techniques, when a computer complies a source program, if a fractional element that is not to be subjected to the SIMD instruction is detected, an object code is generated such that one element is to be operated on at a time by one execution of the operation. That is, in the conventional techniques, although the operation performed on a plurality of fractional elements is the same as the operation performed by the SIMD instruction, the SIMD instruction is not applied to these fractional elements, and thus a sufficient improvement in efficiency of the iterative operation is not achieved.

### SUMMARY

According to an aspect of the embodiments, a code generation apparatus includes a memory configured to store a first program including a loop process that performs a same operation on each of a plurality of operation elements set in an array; and a processor configured to execute a process of generating a second program according to the first program, the second program including: a first process in which an operation according to a first operation instruction is performed on operation elements iteratively such that each iteration is performed on as operation elements as a number of operand elements, the operation element being extracted from the array in an order for starting from a top element of the array, the iteration being performed as times as a number specified by a quotient obtained as a result of an integer division of a total number of operation elements by the number of operand elements for indicating a unit number of operation elements operated on by one operation instruction; a second process in which a mask bit string including as mask bits as the number of operand elements is set such that a first mask bits included in the mask bit string and including as mask bits as a remainder of the division are each set to a value for indicating truth, while one or more second mask bits included in the mask bit string other than the first mask bits are each set to a value for indicating false; and a third process in which the operation is performed on as respective elements as the number of operand elements according to second operation instruction, the elements including one or more remainder operation elements not subjected to the operation in the first process and one or more non-operation elements excluded from being operated on as the number of operand elements, the operation according to the second operation instruction being performed such that each remainder operation element is assigned one of the first mask bits, each non-operation element is assigned one of second mask bits, a result of the operation for an element assigned a truth mask bit is output, and a result of the operation for an element assigned a false mask bit is not output.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for illustrating an example of a functional configuration of a code generation apparatus according to a first embodiment;

FIG. 2 is a diagram for illustrating an example of a hardware configuration of a computer used in a second embodiment;

FIG. 3 is a diagram for illustrating a relationship between a SIMD width and the number of SIMD elements;

FIG. 4 is a diagram for illustrating a first example of an application of a SIMD instruction;

FIG. 5 is a diagram for illustrating a second example of an application of a SIMD instruction;

FIG. 6 is a diagram for illustrating a noSIMD ratio depending on a number of iterations for each SIMD width;

FIG. 7 is a diagram for illustrating an example of a program including nested loop processes;

FIG. 8 is a diagram for illustrating an example of a manner of applying SIMD instructions using a mask instruction;

FIG. 9 is a diagram for illustrating an example of a manner of applying SIMD instructions on remainder elements;

FIG. 10 is a diagram for illustrating an example of a manner of converting a loop process to SIMD instructions;

FIG. 11 is a block diagram for illustrating an example of a function of a computer;

FIG. 12 is a diagram for illustrating an example of loop configuration information;

FIG. 13 is a flow chart for illustrating an example of a procedure of a process performed by a loop output section;

FIG. 14 is a flow chart for illustrating an example of a procedure of a remainder loop conversion process; and

FIG. 15 is a diagram illustrating an example of a manner of setting mask bit values using a comparison instruction.

### DESCRIPTION OF EMBODIMENTS

Embodiments of the present disclosure are described below with reference to drawings. Note that two or more embodiments may be combined unless a conflict occurs.

### First Embodiment

First, a first embodiment is described below. In the first embodiment, a code generation method for generating a program capable of efficiently executing an iterative process of the same operation is realized by a code generation apparatus. A process executed by the code generation apparatus may be realized, for example, by controlling a computer to execute a code generation program including a processing procedure of the code generation method.

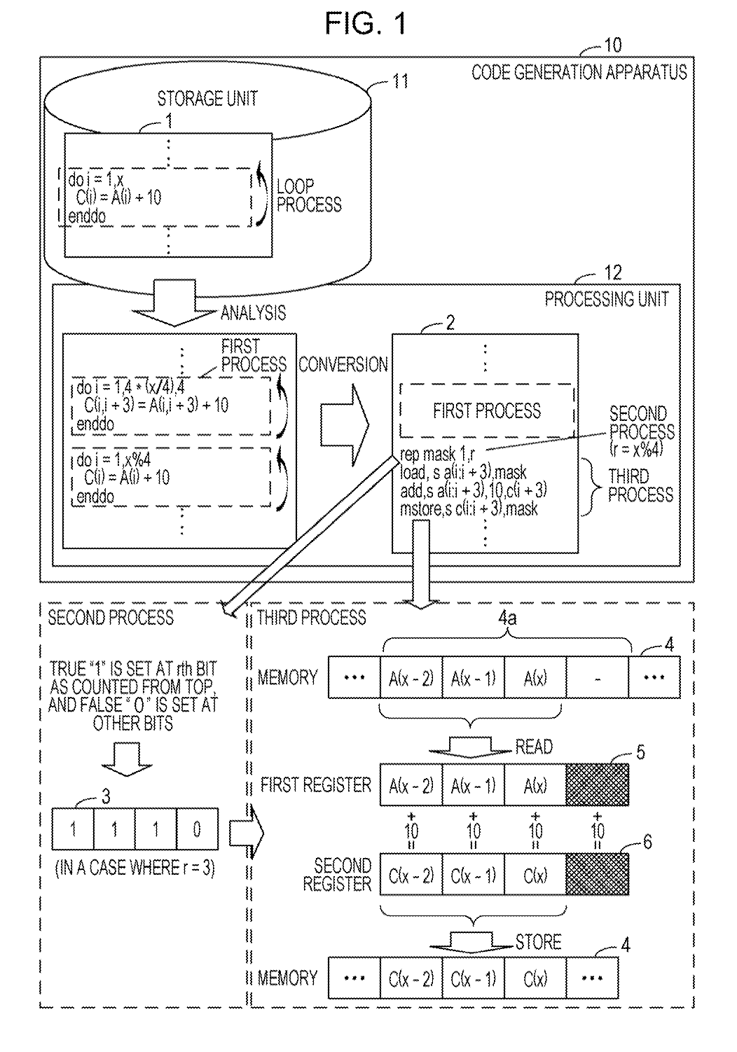

FIG. 1 is a diagram for illustrating an example of a functional configuration of a code generation apparatus according to the first embodiment. A code generation apparatus 10 is, for example, a computer. The code generation apparatus 10 includes a storage unit 11 and a processing unit 12. The storage unit 11 is, for example, a memory or a storage apparatus. The processing unit 12 is, for example, a processor.

The storage unit 11 stores a first program 1 including a description of a loop process in which the same operation is performed on a plurality of respective elements set in an array. The processing unit 12 generates a second program 2 based on the first program 1. First to third processes are described in the second program 2.

The first process is a process in which an operation according to a first operation instruction is performed on operation elements iteratively such that each iteration is performed on as many operation elements as a number of operand elements, the operation element being extracted sequentially from the array in the order for starting from a top element of the array. The number of operand elements refers to the number of elements operated on by one operation instruction. In a case where an operation instruction is a SIMD instruction, the number of operand elements is the number of elements on which the SIMD instruction operates in parallel. The number of iterations of an operation according to a first operation instruction is given by a quotient obtained as a result of an integer division in which a dividend is a total number of elements to be subjected to the operation, and a divisor is the number of operand elements.

A second process is a process of setting values at mask bits in a mask bit string 3 including as many mask bits as the number of operand elements. In the second process, a value for indicating truth is set at as many first mask bits as the number given by a remainder that occurs in a result of an integer division in which a dividend is given by the total number of elements to be subjected to the operation, and a divisor is given by the number of operand elements. Furthermore, in the second process, a value for indicating false is set at second mask bits in the mask bit string 3 other than the first mask bits.

The third process is a process in which the operation is performed on as many respective elements 4a as the number of operand elements according to second operation instruction using the mask bit string 3. The elements 4a includes one or more remainder operation elements not subjected to the operation in the first process and one or more non-operation elements excluded from being operated on. The second operation instruction is an operation instruction that outputs a result of the operation performed on elements corresponding to mask bits with a value of truth but that does not output a result of the operation on elements corresponding to mask bits with a value of false. In the second operation instruction, the remainder elements in the plurality of elements 4a, are assigned the first mask bits, and the non-operation elements in the plurality of elements 4a are assigned the second mask bits. The second operation instruction may be, for example, a SIMD instruction with mask.

For example, the second operation instruction includes a load instruction, a third operation instruction, and a store instruction. The load instruction is an instruction to load a plurality of elements from the memory 4 of the computer that executes the second program 2 into a first register 5 included in the processor of the computer. The third operation instruction is an instruction to perform an operation on the respective elements loaded in the first register 5 and stores a result of the operation into a second register 6 in the processor of the computer that executes the second program 2. The store instruction is an instruction to load an operation result for elements corresponding to mask bits with a value of truth from the second register 6 into the memory 4 of the computer that executes the second program 2 and does not store an operation result for elements corresponding to mask bits with a value of false.

The load instruction, which is included in the second operation instruction, may be, for example, an instruction to load elements corresponding to mask bits with a value of truth into the first register 5 and not to load elements corresponding to mask bits with a value of false.

The code generation apparatus 10 configured in the above-described manner generates the second program 2 capable of executing an operation on all elements, which are specified to be processed in a loop process in the first program 1, in parallel using a SIMD instruction. Use of the second program 2 makes it possible for a computer to handle all remainder elements by one execution of a SIMD instruction with mask, and thus it becomes possible to efficiently execute an iterative process of the same operation.

Furthermore, by using, as a load instruction included in the SIMD instruction with mask, an instruction that does not allow it to read any SIMD operation element corresponding to a mask bit with a value of false, it becomes possible to avoid the occurrence of an error even in a case where a given non-operation element is undefined. That is, in general, if a processor tries to read out undefined data from a memory, an error occurs. By avoiding the occurrence of such an error, it becomes possible for the second program 2 generated by the code generation apparatus 10 to be capable of being used by many computers, which results in an increase in versatility of the second program 2.

### Second Embodiment

Next, a second embodiment is described below. In the second embodiment, when a source program is interpreted by a compiler into a machine language, a mask instruction is used together with a SIMD instruction such that the number of executions of the instruction is reduced thereby achieving an improvement in performance.

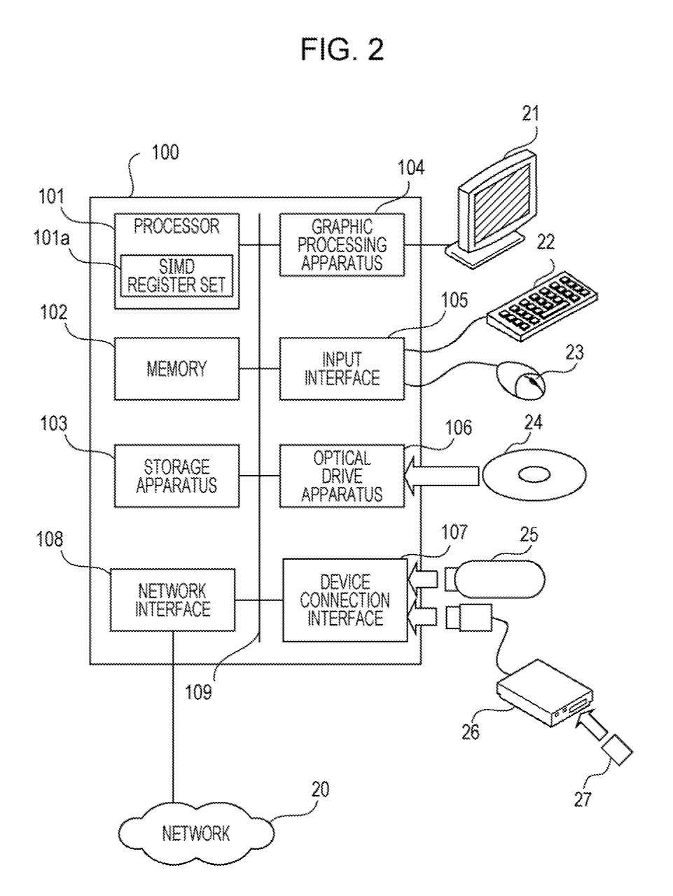

FIG. 2 is a diagram for illustrating an example of a hardware configuration of a computer used in the second embodiment. The whole of the computer 100 is controlled by a processor 101. The processor 101 is connected to a memory 102 and a plurality of peripheral devices via a bus 109. The processor 101 may be a multiprocessor. The processor 101 is, for example, a Central Processing Unit (CPU), an Micro Processing Unit (MPU), or a Digital Signal Processor (DSP). At least part of functions realized by the processor 101 by executing a program may be realized by an electronic circuit such as an Application Specific Integrated Circuit (ASIC), a Programmable Logic Device (PLD), or the like. The processor 101 also includes a SIMD register set 101a. The SIMD register set 101a is a set of registers each having a data width that allows it to store SIMD Extensions.

The memory 102 is used as a main memory of the computer 100. The memory 102, stores at least part of an Operating System (OS) program and an application program to be executed by the processor 101. The memory 102 also stores various kinds of data used in a process by the processor 101. As for the memory 102, for example, a volatile semiconductor memory device such as a Random-Access Memory (RAM) may be used.

The peripheral devices connected to the bus 109 may include a storage apparatus 103, a graphic processing apparatus 104, an input interface 105, an optical drive apparatus 106, a device connection interface 107, and a network interface 108.

The storage apparatus 103 electrically or magnetically writes and reads data to or from a storage medium disposed therein. The storage apparatus 103 is used as an auxiliary storage apparatus of the computer. The storage apparatus 103 stores an OS program, an application program, and various kinds of data. As for the storage apparatus 103, for example, an Hard Disk Drive (HDD) or an Solid-State Drive (SSD) may be used.

The graphic processing apparatus 104 is connected to a monitor 21. The graphic processing apparatus 104 displays an image on a screen of the monitor 21 according to an instruction given from the processor 101. As for the monitor 21, for example, a display apparatus using a Cathode Ray Tube (CRT), a liquid crystal display apparatus, or the like may be used.

The input interface 105 is connected to a keyboard 22 and a mouse 23. The input interface 105 receives a signal from the keyboard 22 or the mouse 23 and transfers the received signal to the processor 101. The mouse 23 is an example of a pointing device. Instead of the mouse 23, other types of pointing devices may be used. As for the other types of pointing devices, a touch panel, a tablet device, a touch pad, a trackball, or the like may be used.

The optical drive apparatus 106 reads out data stored on an optical disk 24 using a laser beam or the like. The optical disk 24 is a portable storage medium capable of storing data such that the data can be read out by reflection of light. Examples of the optical disk 24 include a Digital Versatile Disc (DVD), a DVD-RAM, a Compact Disc Read Only Memory (CD-ROM), a CD-R (Recordable)/RW (ReWritable), etc.

The device connection interface 107 is a communication interface for connecting a peripheral device to the computer 100. For example, the device connection interface 107 may be connected to a memory apparatus 25, a memory reader/writer 26, and/or the like. The memory apparatus 25 is a storage medium having a function of communicating with the device connection interface 107. The memory reader/writer 26 is an apparatus adapted to write data to the memory card 27 or read out data from the memory card 27. The memory card 27 is a card-type storage medium.

The network interface 108 is connected to a network 20. The network interface 108 transmits/receives data to/from another computer or communication device via the network 20.

The processing functions according to the second embodiment can be realized using the hardware configuration described above. Note that the apparatus according to the first embodiment can also be realized by hardware similar to the computer 100 illustrated in FIG. 2.

The computer 100 may realize the functions according to the second embodiment, for example, by executing a program stored in a computer-readable storage medium. One or more of various storage media may be used to store the program including a content to be executed by the computer 100. For example, the program to be executed by the computer 100 may be stored in the storage apparatus 103. The processor 101 may load, into the memory 102, at least part of the program stored in the storage apparatus 103 and may execute the loaded program. The program to be executed by the computer 100 may be stored in a portable storage medium such as the optical disk 24, the memory apparatus 25, the memory card 27, or the like. For example, under the control of the processor 101, the program stored in the portable storage medium may be installed in the storage apparatus 103 before the program is executed. Alternatively, the processor 101 may directly read out the program from the portable storage medium and may execute the program.

The computer 100 illustrated in FIG. 2 may execute a complier program to compile a source program described in a high-level language such as FORTRAN, C, or the like, and may output a resultant execution program described in a machine language. In the second embodiment, when the computer 100 complies a source program, a loop process to which a SIMD instruction using the SIMD register set 101a can be applied may be converted to the SIMD instruction. In the following discussion, it is assumed by way example that the source program is described in FORTRAN although there is no particular restriction on the language of the source program.

Note that the program in an executable format generated from the source program via the compilation by the computer 100 can be executed not only by the computer 100 but by computers other than the computer 100. In the following discussion, it is assumed by way of example that the generated executable program is executed by the computer 100.

When a SIMD instruction is executed, the processor 101 performs an operation in units of SIMD elements each having a particular SIMD width and stores an operation result in units of SIMD elements in the memory 102. The number of SIMD elements in the execution of the SIMD instruction is determined based on the SIMD width.

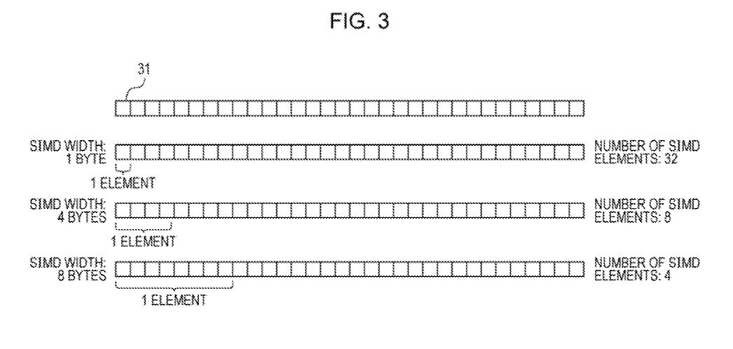

FIG. 3 illustrates a relationship between the SIMD width and the number of SIMD elements. In the example illustrated in FIG. 3, the capacity of the SIMD register 31 is 32 bytes. In this case, when the SIMD width is 1 byte, the number of SIMD elements is 32. When the SIMD width is 4 bytes, the number of SIMD elements is 8. When the SIMD width is 8 bytes, the number of SIMD elements is 4.

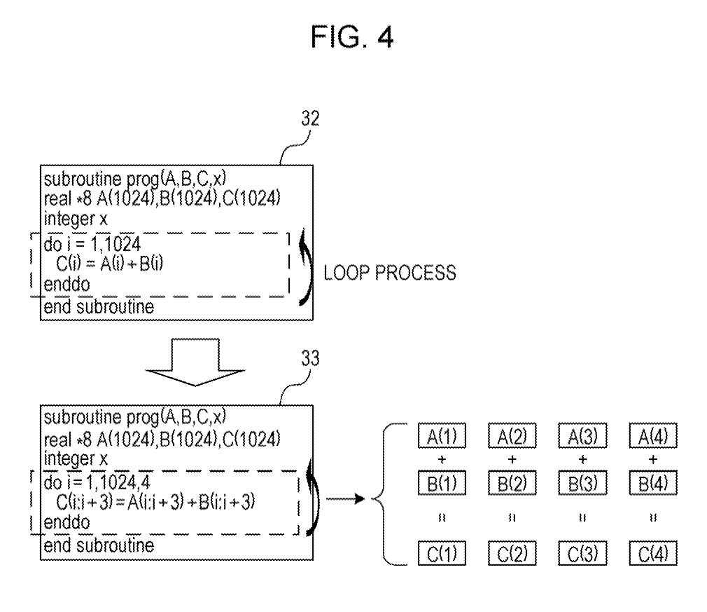

In the following discussion, it is assumed by way of example that the SIMD register 31 has a capacity of 32 bytes, the SIMD width is 8 bytes, and the number of SIMD elements is 4. FIG. 4 illustrates a first example of a manner of applying a SIMD instruction. When a SIMD instruction is applied, the computer 100 rewrites a subroutine 32 of a loop process into a form that allows the application of the SIMD instruction. For example, the subroutine 32 is rewritten into the subroutine 33 such that an add instruction in the loop process is rewritten into an instruction “C(i:i+3)=A(i:i+3)+B(i:i+3)” that is an instruction to acquire from elements from each of an array A and an array B, and add the respective corresponding elements (where i is an integer equal to or greater than 1). That is, this instruction is an instruction to add ith to (i+3)th elements of the array A with respective ith to (i+3)th elements of the array B, and set resultant sums in respective ith to (i+3)th elements of an array C. When a compilation is performed, the rewritten instructions are replaced with SIMD instructions in a machine language.

In the example illustrated in FIG. 4, it is assumed that the number of iterations of the loop (the number of iterations of the loop in the state in which the conversion to the SIMD instruction is not yet performed) is equal to an integral multiple of the number of SIMD elements that can be handled by one execution of the SIMD instruction. That is, in the example in FIG. 4, when the number of iterations of the loop is divided by the number of SIMD elements, no remainder occurs, that is no remainder of elements to be operated on.

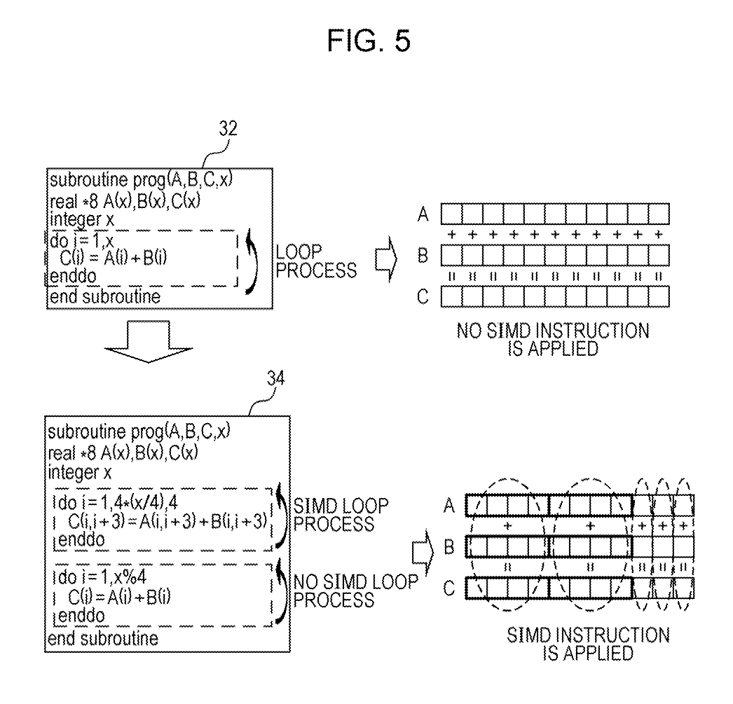

In a case where a remainder of elements to be operated on occurs, the computer 100 rewrites the program taking into account the occurrence of the remainder. FIG. 5 illustrates a second example of a manner of applying a SIMD instruction. In the example illustrated in FIG. 5, a loop process in the original subroutine 32 is divided in two loop processes in a rewritten subroutine 34. One of the two loop processes is a loop process (a SIMD loop process) to which a SIMD instruction is to be applied. The other one is a loop process (a noSIMD loop process) to which a SIMD instruction is not to be applied.

In the rewritten subroutine 34, the number of iterations of a SIMD loop process is given by a quotient (x/4) obtained as a result of dividing a variable (x) for indicating the number of iterations of the loop in the original subroutine 32 by the number of SIMD elements (4). Furthermore, in the rewritten subroutine 34, the number of iterations of a noSIMD loop process is given by a remainder (x % 4) obtained as a result of dividing the variable (x) for indicating the number of iterations of the loop in the original subroutine 32 by the number of SIMD elements (4).

In the subroutine 34, the noSIMD loop process is executed after the SIMD loop process is ended. An operation process is executed on an element-by-element basis on the remainder elements existing after the SIMD instruction is applied in the SIMD loop process.

Next, an influence of a noSIMD loop process on a process efficiency is discussed below for a case where the compilation result includes the noSIMD loop process as with the case of the subroutine 34.

As for the relationship among the number of iterations of the loop process in the original subroutine 32, the number of iterations of the noSIMD loop process in the rewritten subroutine 34, and the number of iterations of the noSIMD loop process, there is a relationship described below.

The number of iteration of loop=the number of SIMD elements×the number of iterations of the SIMD process+the number of iterations of the noSIMD process.

The number of iterations of the noSIMD process is smaller than the number of SIMD elements, and thus if the number of iterations and the number of SIMD elements are determined, the number of iterations of the SIMD process and the number of iterations of the noSIMD process are uniquely determined. For example, if the number of iterations is 111 and the number of SIMD elements is 4, then the number of iterations of the SIMD process is 27 and the number of iterations of the noSIMD process is 3 (111=4×27+1×3).

Here, let the noSIMD ratio be defined by the ratio (the noSIMD ratio) of the number of iterations of the noSIMD process to the sum of the number of iterations of the SIMD process and the number of iterations of the noSIMD process in the state in which the SIMD instruction is applied. As the noSIMD ratio decreases, the operation efficiency due to the use of the SIMD instruction Increases.

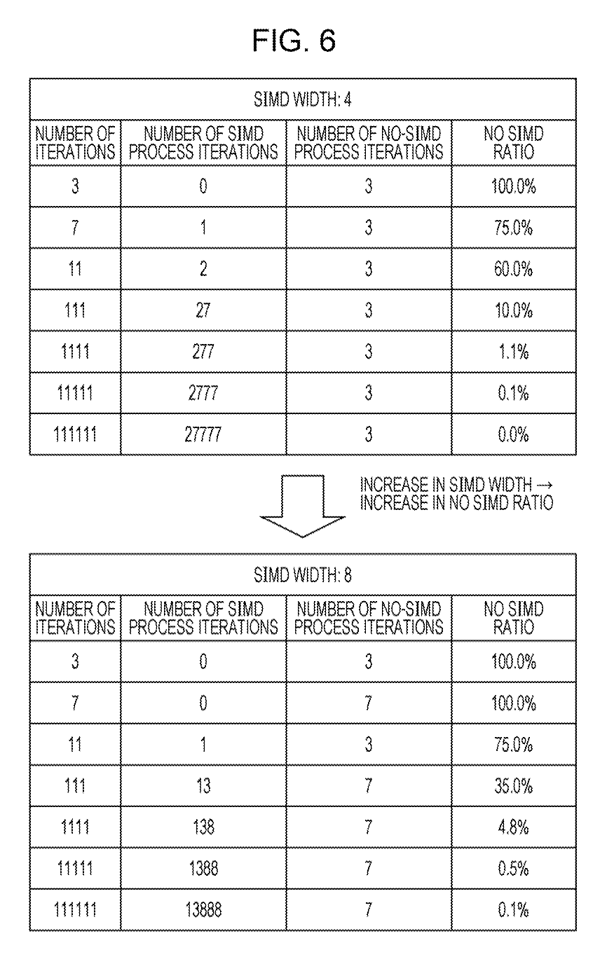

FIG. 6 is a diagram for illustrating a noSIMD ratio depending on a number of iterations for each SIMD width. As illustrated in FIG. 6, when the number of iterations is sufficiently large, a great effect is obtained by using a SIMD instruction capable of concurrently executing an operation on a plurality of elements, and the number of iterations of the SIMD process is larger than the number of iterations of the noSIMD process. Thus, it is possible to achieve a sufficiently large increase in performance.

However, when the number of iterations is small, the noSIMD ratio is large. When the SIMD width is large, the noSIMD ratio is large compared with a case where the SIMD width is small. When the noSIMD ratio is large, the SIMD effect obtained by applying the SIMD instruction is low. Furthermore, when the SIMD instruction is applied, an additional process such as a decision statement occurs owing to a division of a loop or the like, and thus there is a possibility that the applying of the SIMD instruction may cause the performance to be worse than is obtained when the SIMD instruction is not applied.

In particular, in a case where a program has a structure in which a SIMD loop that is iterated by a small number of times is repeatedly called from a higher-level loop, the applicating of the SIMD instruction may result in a large reduction in performance.

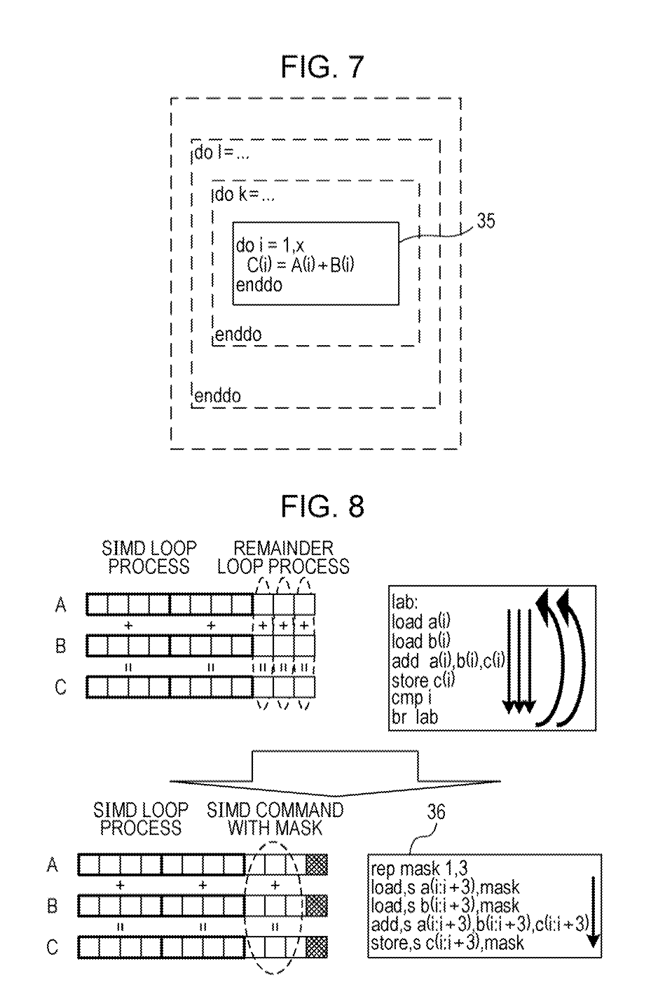

FIG. 7 is a diagram illustrating an example of a program including nested loop process. In this example illustrated in FIG. 7, a loop process 35 is to be subjected to the conversion to SIMD instructions. This loop process 35 is repeatedly called from another loop process. If this loop process 35 is iterated by a small number of times (×) and thus the noSIMD ratio is high, applying of the SIMD instruction to the loop process 35 may not bring an advantage of parallel processing using the SIMD instruction. In fact, when the SIMD instruction is applied to the loop process 35, there is a possibility that an increase in the number of branch instructions caused by dividing a loop may result in a worse performance than is obtained when the SIMD instruction is not applied.

As described above, in a case where a loop process is divided into a noSIMD loop process and a noSIMD loop process, if the number of iterations is small, the noSIMD ratio may increase, which may result in degradation in performance. To handle the above-described situation, in the second embodiment, a mask instruction is used to make it possible to apply a SIMD instruction to even a process which would otherwise be treated as a noSIMD loop process thereby avoiding degradation in performance and thus achieving an increase in operation speed.

FIG. 8 is a diagram illustrating an example of an application of a SIMD instruction using a mask instruction. A remainder loop process, to which the noSIMD loop process would be applied in the example illustrated in FIG. 5, is converted by the computer 100 to a SIMD instruction with mask thereby making it possible for a resultant generated program to achieve an increase in efficiency. For example, the computer 100 converts the loop process (remainder loop process), in which the number of elements is smaller than the number of SIMD elements, to a SIMD program 36 on the remainder loop. In the SIMD program 36 on the remainder loop, the remainder loop process is replaced by a single SIMD instruction. Hereinafter, the replacement of a remainder loop process by a single SIMD instruction will be referred to as the conversion of the remainder loop process to the SIMD instruction.

For example, in a case where the number of SIMD elements operated on by the SIMD instruction is 8, the computer 100 performs a conversion to a SIMD program 36 on the remainder loop when the number of elements subjected to the same operation is 7 or less. In a case where the number of SIMD elements in the SIMD instruction is 4, the computer 100 performs a conversion to a SIMD program 36 on the remainder loop when the number of elements subjected to the same operation is three or less. In the following description, it is assumed by way of example that the number of SIMD elements in the SIMD instruction is 4.

In the example illustrated in FIG. 8, if the conversion to the SIMD instruction with mask is not performed, the process is repeated three times in the noSIMD loop process. In contrast, the conversion to the SIMD program 36 on the remainder loop makes is possible to handle the remainder loop process by executing the SIMD instruction once.

In the SIMD program 36 on the remainder loop, a mask instruction specifies a number of elements to be valid in a total of 4 elements in the SIMD register. In the example illustrated in FIG. 8, four elements are operated on concurrently by the SIMD instruction. However, only three elements at successive positions for starting from the top are valid. Thus, a result on the operation on the fourth element is not reflected in the memory 102.

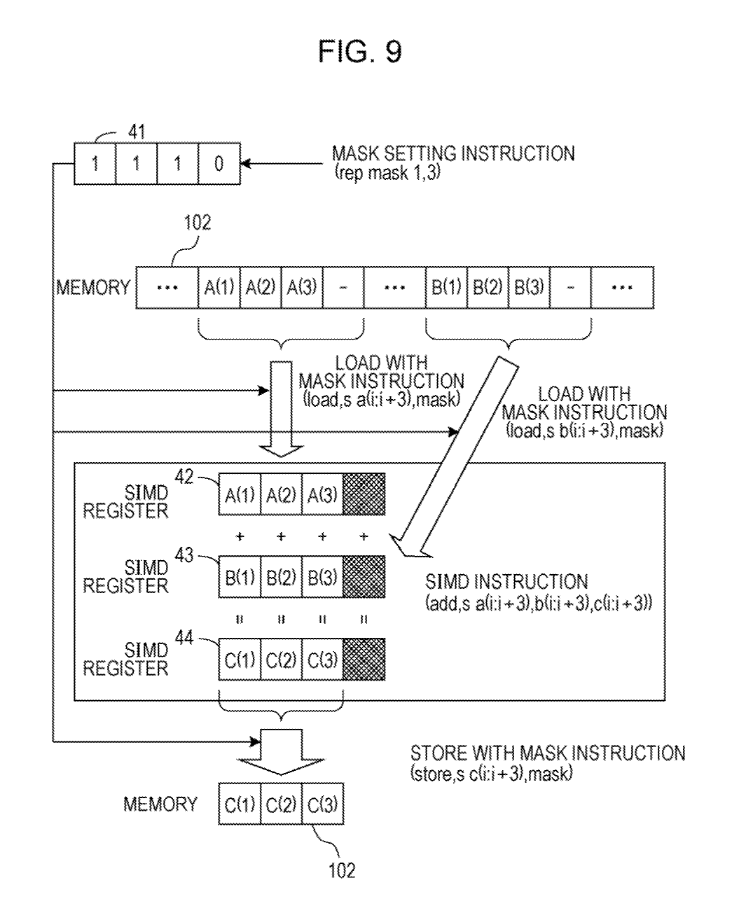

Next, referring to FIG. 9, the content of the instruction in the SIMD program 36 on the remainder loop is described below. FIG. 9 is a diagram for illustrating an example of a process of conversion to SIMD instructions for remainder elements. In general, a mask instruction is prepared to remove a branch in the program that may inhibit optimization in compiling. The mask instruction generates a mask bit string for distinguishing between elements whose results of the operation are valid and elements whose results of the operation are invalid. For example, a mask setting instruction “rep mask 1, 3” generates a mask bit string 41 in which a value of 1 indicating truth is set to first to third bits while a value of 0 indicating false is set to a fourth bit.

In the mask bit string 41, a plurality of mask bits are arranged from left to right for starting from the left-hand end. The bits in the mask bit for string 41 uniquely specify a plurality of elements to be subjected to an operation. More specifically, elements at respective positions in the series of elements correspond to the bits at the same positions in the series of bits. Here let it be assumed by way of example that the elements to be subjected to the operation according to the instruction with mask includes four elements that are serially numbered from i to i+3, that is, the elements include ith to (i+3)th elements. In this case, a bit at the left-hand end of the mask bit string 41 corresponds to the ith element, a bit at the second position from the left-hand end corresponds to the (i+1)th element, a bit at the third position from the left-hand end corresponds to the (i+2)th element, and a bit at a right-hand end corresponds to the (i+3)th element.

After the mask bit string 41 is generated, elements in the array A are loaded from the memory 102 into the SIMD register 42 according to a load instruction with mask “load, s a(i:i+3), mask”. In this loading process, the mask bit string 41 is referred to, and only the elements corresponding to the truth bits are loaded from the memory 102.

Next, elements in the array B are loaded from the memory 102 into the SIMD register 43 according to a load instruction with mask “load, s b(i:i+3), mask”. In this loading process, the mask bit string 41 is referred to, and only the elements corresponding to the truth bits are loaded from the memory 102.

Thereafter, the elements of the array A are added respectively with the corresponding elements of the array B according to a SIMD instruction “add, s a(i:i+3), b(i:i+3), c(i:i+3)” such that an element of the array A with a variable i is added with an element of the array B with the same variable i for respective i values. Respective resultant sums are stored as elements of the array C in the SIMD register 44. Thereafter, the values of the respective elements in the SIMD register 44 are stored into the memory 102 according to a store instruction with mask “store, s c(i:i+3), mask”. In this storing process, the mask bit string 41 is referred to, and only the elements corresponding to the truth bits are stored into the memory 102.

The above-described conversion of the remainder loop process to the SIMD instruction is realized by using two techniques described below.

(1) Avoiding Access to Elements not to be Subjected to the Operation

The number of elements processed in the converted SIMD instruction on the remainder loop is smaller than the number of SIMD elements. When the SIMD instruction is applied, a non-existing element (an undefined element) is exempted from being processed. When data is loaded in units of as many elements as the number of SIMD elements from the memory 102, there is a possibility that an area in which an undefined element is stored is directly accessed. In the second embodiment, to handle the above situation, the conversion of the remainder loop to SIMD instructions is performed using a load instruction with mask such that only the elements to be actually processed are loaded. The load instruction with mask is an instruction to load only the elements to be processed in the SIMD elements from the memory 102 to the register according to the mask specification. In the example illustrated in FIG. 9, when a load instruction is executed, masking is performed such that an undefined data element is not loaded thereby ensuring that only elements to be operated on by SIMD instructions are allowed to be accessed and any element in a non-operation area is not allowed to be accessed.

Note that in the example illustrated in FIG. 9, it is assumed that the processor 101 supports the load/store instruction with mask. In a case where the processor 101 does not support the load instruction with mask, instead of the load instruction with mask, it may be allowed to use a load instruction that does not result in an occurrence of an interrupt even when an invalid area is accessed. The load instruction that does not result in an occurrence of an interrupt even when an invalid area is accessed is also used in a prefetch instruction which has a high probability that an invalid area is accessed, and thus many processors support this type of load instruction.

(2) Generating Mask Bit String 41

The mask process is generally used to reduce branches. In the mask process for reducing branches, whether a condition is satisfied or not is reflected in mask bits. In the conversion of remainder loop processes to SIMD instructions, mask bits are set so as to explicitly indicate only valid elements. That is, mask bits corresponding to non-existing elements are set to a value of “0” for indicating false such that loading undefined data elements is not allowed when the load instruction with this mask is executed.

By using a store instruction with mask that set in a similar manner, it is ensured that elements corresponding to mask bits set to a value of “0” for indicating false are excluded from candidates that may be stored in the memory 102. In the second embodiment, when the computer 100 complies a source program, the computer 100 performs the conversion of remainder loop processes to SIMD instructions. For example, the computer 100 may specify, in an interpretation option of compiling, that a SIMD instruction is to be applied. By describing an Object Constraint Language (OCL) statement or pragma (#pragma) in a source program, it is possible to explicitly specify that a SIMD instruction is to be used. In this case, the computer 100 analyzes the source program, and if the computer 100 detects a statement for specifying that a SIMD instruction is to be applied, the computer 100 outputs an object code using the SIMD instruction. In this process, the SIMD instruction is applied also to remainder loop processes.

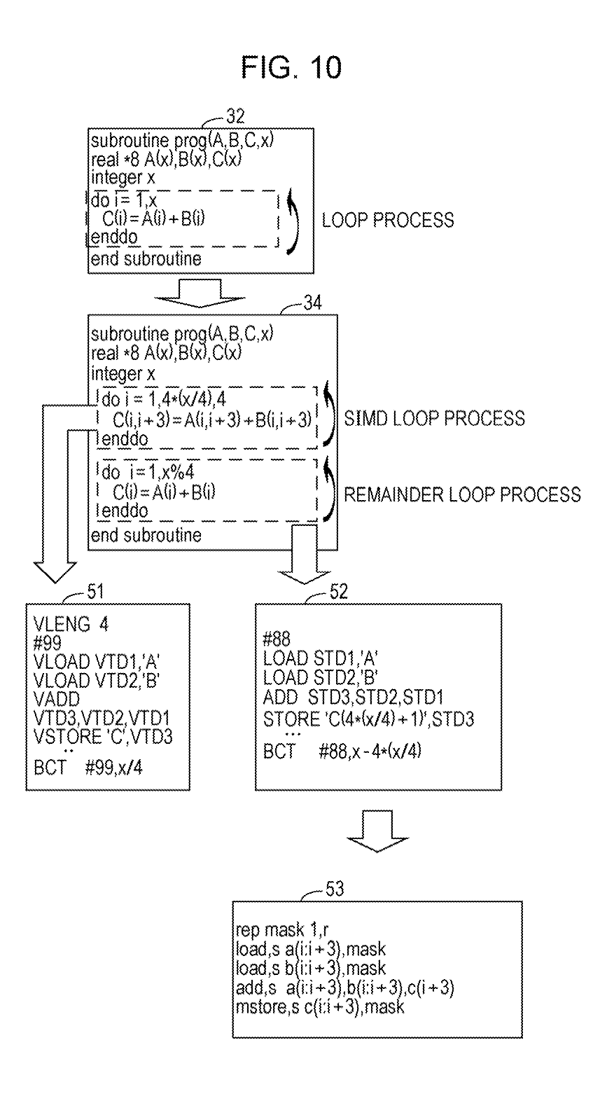

FIG. 10 is a diagram for illustrating an example of a manner of converting a loop process to SIMD instructions. In the example illustrated in FIG. 10, the computer 100 generates a subroutine 34 from a subroutine 32, to be converted to SIMD instructions, in a source program such that a loop process in the original subroutine 32 is divided into a noSIMD loop process and a remainder loop process in the resultant subroutine 34. Next, the computer 100 converts the subroutine 34 to a program in an intermediate language (an intermediate program) and further converts this intermediate program to an object code.

For example, the noSIMD loop process and the remainder loop process in the subroutine 34 are respectively converted to intermediate programs 51 and 52. At this stage, no SIMD instruction is used in the intermediate program 52 of the remainder loop process. The intermediate program 52 of the remainder loop process is then analyzed and a SIMD conversion program 53 for including SIMD instruction with mask is generated. In FIG. 10, statements in the SIMD program on the remainder loop 53 are described in a low-level language having a one-to-one correspondence to a machine language. An object code is generated by replacing each statement in the SIMD conversion program 53 on the remainder loop in FIG. 10 by a corresponding machine language code.

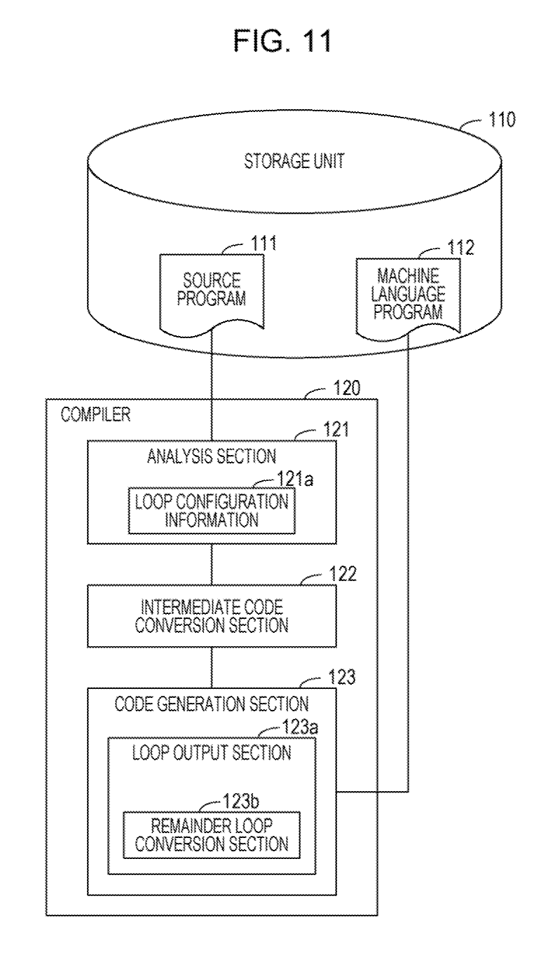

Next, a function of a compiler for performing a SIMD conversion including remainder loop processes is described below. FIG. 11 is a block diagram for illustrating an example of a function of a computer. The computer 100 includes a storage unit 110 and a compiler 120. The storage unit 110 is, for example, the memory 102 or the storage apparatus 103. The compiler 120 is a function realized by executing a complier program on the computer 100.

The storage unit 110 stores a source program 111, and a machine language program 112 generated as a result of interpreting the source program 111. The compiler 120 includes an analysis section 121, an intermediate code conversion section 122, and a code generation section 123.

The analysis section 121 analyzes the source program 111. When the analysis section 121 detects a loop process in the source program 111, the analysis section 121 generates loop configuration information 121a. The loop configuration information 121a includes information for indicating whether the loop process is to be converted to SIMD instructions, a parameter value used in SIMD conversion, and the like.

The intermediate code conversion section 122 converts the source program 111 to an intermediate code based on a result of the analysis made by the analysis section 121. For example, the intermediate code conversion section 122 divides a loop process included in the subroutine 32 (see FIG. 10) into a noSIMD loop process and a remainder loop process, and generates an intermediate program 51 for describing the noSIMD loop process and an intermediate program 52 for describing the remainder loop process.

The code generation section 123 generates a machine language code based on the intermediate code generated by the intermediate code conversion section 122. The code generation section 123 includes a loop output section 123a. The loop output section 123a converts the loop process in the intermediate code to code in a machine language. The loop output section 123a includes a remainder loop conversion section 123b. The remainder loop conversion section 123b converts a remainder loop process in the loop process to SIMD code in a machine language.

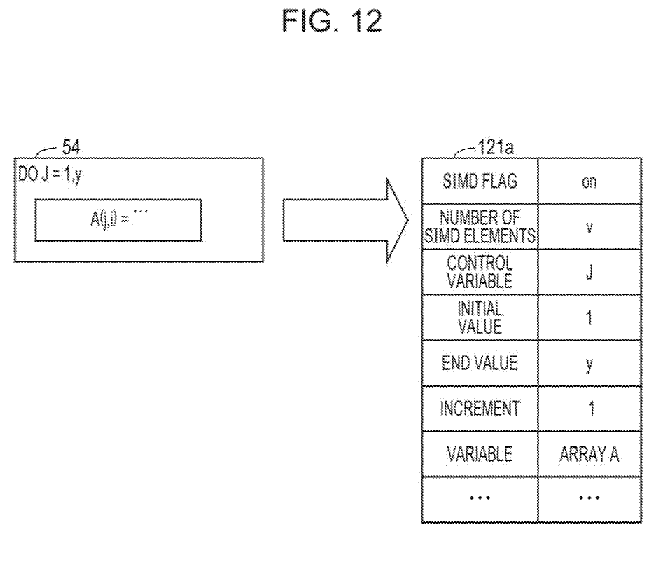

The function of each element in FIG. 11 can be realized, for example, by controlling a computer to execute a program module corresponding to the element. FIG. 12 illustrates an example of loop configuration information. The loop configuration information 121a is generated by analyzing a part (loop process part 54) for describing a loop process in the source program 111. The loop configuration information 121a includes information in terms of a SIMD flag, the number of SIMD elements, a control variable, an initial value, an end value, an increment, a variable, etc. The SIMD flag is a flag for indicating whether SIMD conversion is performed. For example, in a case where SIMD conversion is to be performed, the SIMD flag is set to “on”. The number of SIMD elements indicates the number of loop iterations. The control variable is a variable for indicating the order of an element to be subjected to the operation. The initial value is an initial value of the control variable. The end value is a maximum value of the control variable. The increment is a value by which the control variable is incremented each time a process of one loop is executed. The variable is a variable or an array for indicating an element to be subjected to the operation.

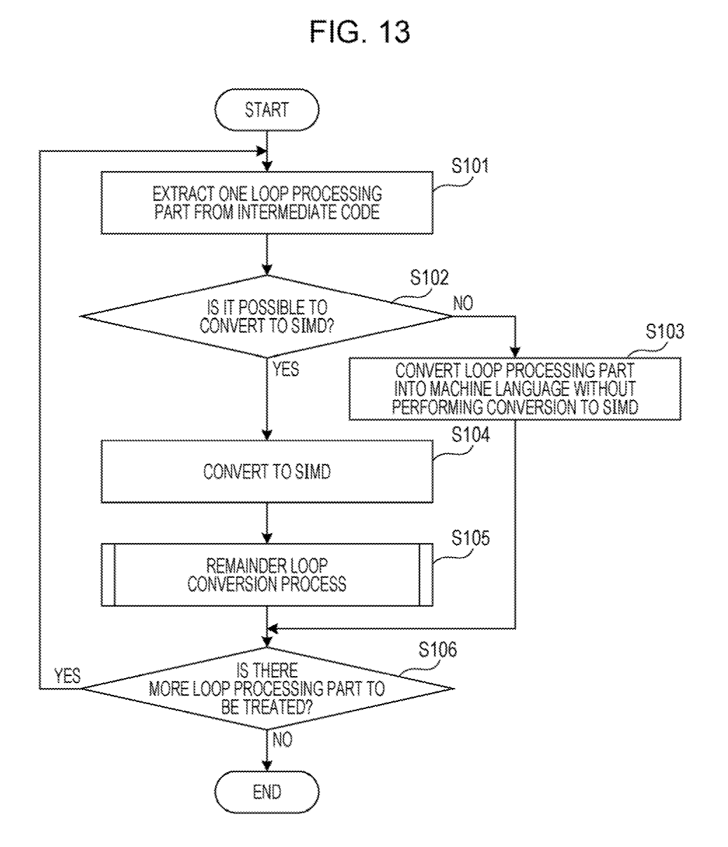

Next, the process performed on the source program 111 by loop output section 123a during the compilation is described in detail below. FIG. 13 is a flow chart for illustrating an example of a procedure of a process performed by the loop output section. The process illustrated in FIG. 13 is described below in the order of step number.

Step S101. The loop output section 123a extracts one untreated loop process part from the loop process included in intermediate code generated as a result of analyzing the source program 111.

Step S102. The loop output section 123a determines whether a process in the extracted loop process part can be converted into a SIMD instruction. For example, if the value of the SIMD flag in the loop configuration information 121a corresponding to the extracted loop process part is “on”, then the loop output section 123a determines that the conversion into a SIMD instruction is possible. For example, in a case where a plurality of elements subjected to the operation in the loop process are stored in successive areas in the memory 102, the loop process part for describing the procedure of the loop process can be converted to a SIMD instruction. In a case where conversion to a SIMD instruction is possible, the loop output section 123a advances the processing flow to step S104. On the other hand, in a case where conversion to a SIMD instruction is not possible, the loop output section 123a advances the processing flow to step S103.

Step S103. The loop output section 123a converts the extracted loop process part into machine language code without converting the extracted loop process part to a SIMD instruction. Thereafter, the loop output section 123a advances the processing flow to step S106.

Step S104. The loop output section 123a performs the SIMD conversion process on a noSIMD loop process part other than a remainder loop process. For example, in a case where the number of iterations of the loop (the number of elements to be operated on) is not known yet when the compiling is performed, the loop output section 123a divides the loop process part into a part for describing a noSIMD loop process (SIMD process part) and a part for describing the remainder loop process (the remainder loop process part). Also in a case where the number of iterations of the loop is fixed but a remainder occurs when the total number of elements to be operated on is divided by the SIMD width, the loop output section 123a divides the extracted loop process part into a noSIMD loop process part and a remainder loop process part. In step S104, the loop output section 123a converts only the noSIMD loop process part to a machine language code for describing the loop process processed in parallel using the SIMD instruction.

Step S105. The remainder loop conversion section 123b performs a remainder loop conversion process,

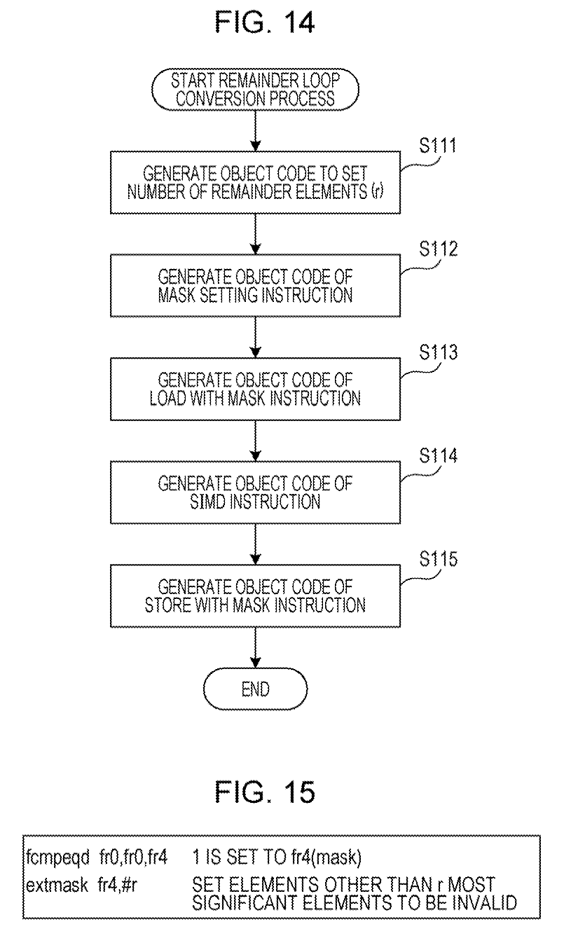

which will be described in detail later (see FIG. 14). Step S106. The loop output section 123a determines whether the intermediate code includes an unprocessed loop process part. In a case where there is an unprocessed loop process part, the loop output section 123a advances the processing flow to step S101. When all loop process parts have been processed, the loop output section 123a ends the processing flow.

Next, the remainder loop conversion process is described in detail. FIG. 14 is a flow chart for illustrating an example of a procedure of a remainder loop conversion process. The process illustrated in FIG. 14 is described below in the order of step number.

Step S111. The remainder loop conversion section 123b generates an object code of an instruction that sets, in a variable r, the number of elements (the number of remainder elements) to be subjected to the operation in the remainder loop process part. The number of remainder elements is a value smaller than the number of SIMD elements. For example, the remainder loop conversion section 123b generates a code in a machine language that instructs a commutation process of “r=x−v×(x/v)” using values in the loop configuration information 121a. Here, x denotes the number of iterations of the loop. v denotes the number of SIMD elements. The number of SIMD elements in the remainder loop process is equal to the number of SIMD elements in the noSIMD loop process, and is, for example, 4. “x/v” is a division operation in which a resultant remainder is discarded.

Step S112. The remainder loop conversion section 123b generates an object code of an instruction to set as many remainder elements to be valid as specified by the variable r. The generated object code is, for example, a code in machine language corresponding to a generation instruction (maskrep 1, r) that generates a mask bit string in which “1” is set at as many most significant mask bits as the number of remainder elements and “0” is set at the remaining other bits.

Step S113. The remainder loop conversion section 123b generates an object code of a load instruction with mask. For example, the remainder loop conversion section 123b generates an object code of a load instruction to load, from the memory 102, only elements corresponding to mask bits having a value of truth in the mask generated by the object code generated in step S112. The load instruction generated in the above-described manner is a SIMD load instruction that does not result in an occurrence of an interrupt even when an invalid mask area is accessed. For example, in the case of an operation using one element of each of the array A and the array B, a machine language code corresponding to an instruction “load, s a(i:i+3), mask” and a machine language code corresponding to an instruction “load, s b(i:i+3), mask” are generated.

Step S114. The remainder loop conversion section 123b generates an object code of a SIMD instruction. For example, a machine language code corresponding to an instruction “add, s a(i:i+3), b(i:i+3), c(i+3)” is generated.

Step S115. The remainder loop conversion section 123b generates an object code of a store instruction with mask. For example, the remainder loop conversion section 123b generates a machine language code of a store instruction with mask to store, in the memory 102, only elements corresponding to mask bits having a value of truth in the mask generated by the code generated in step S112. For example, a machine language code corresponding to an instruction “mstore, s c(i:i+3), mask” is generated.

By executing the program generated in the above-described manner, it is possible to achieve an efficient operation using the SIMD instruction even in the remainder loop process. The improvement in performance is great, in particular, in a case where the number of iterations of the loop process is small when the loop process is handled using a SIMD instruction. In a case where the SIMD width is large, it is possible to handle the remainder loop process by executing the SIMD instruction once, and thus a great increase in performance is achieved.

In comparison, in the conventional techniques, in a case where the number of iterations of the loop process is small when the loop process is handled using a SIMD instruction, the ratio of the noSIMD loop process is low. Therefore, it is difficult to achieve a sufficient advantage of parallel processing using the SIMD instruction. There is a possibility that an increase in the number of branch instructions caused by dividing a loop may result in even degradation in performance. On the other hand, in the second embodiment, even a remainder loop process is converted to a SIMD instruction in the above-described manner such that the resultant SIMD instruction does not have a side effect such as degradation in performance, which ensures that it is possible to achieve an improvement in performance.

In particular, in a case where a program has a structure in which a loop using a SIMD instruction is frequently called by a higher-level loop, the number of iterations of the loop is not known at the stage where the compiling is performed. Thus, the SIMD conversion is performed without taking into account the number of iterations of the loop. If the remainder loop process is not converted to a SIMD instruction as with the conventional techniques, there is a possibility that significant degradation in performance may occur. However, in the second embodiment, even in the case where the number of iterations of the loop is small, it is possible to achieve an increase in operation speed by performing conversion to SIMD instructions.

The greater the SIMD width, the greater the increase in process efficiency achieved by the conversion of the remainder loop process to SIMD instructions. The advance in technology tends to allow processors to handle a larger SIMD width, and future advances in technology will allow a further increase in the SIMD width, which will make it possible for the conversion of the remainder loop process to SIMD instruction to provide a further increase in process efficiency.

### OTHER EMBODIMENTS

The values of the mask bits may be set using a comparison instruction such that “truth” is set only for valid elements.

FIG. 15 is a diagram for illustrating an example of setting mask bit values using a comparison instruction. In the example illustrated in FIG. 15, a fcmpeqd instruction is used. This instruction takes three arguments, for example, as with “fcmpeqd reg1, reg2, reg3”. In the fcmpeqd instruction, a value of reg1 is compared with a value of reg2. If these values are equal, “1” is set in reg3. However, if the values are not equal, “0” is set in reg3. By using “fcmpeqd ft0, fr0, fr4”, it is possible to set “1” at all bits of fr4 used as a mask bit string.

An extmask instruction takes two arguments as “extmask reg1, #x”. The extmask instruction is an instruction to set bit values such that “1” is set bits at positions from the most significant bit to x and “0” is set at the other bits. By using “extmask fr4, #r”, it is possible to set a value of “0” for indicating invalidity at all bits including the rft bit as counted from the MSB and following bits.

In the second embodiment, the conversion of a remainder loop process to SIMD instructions is performed when an intermediate code is converted to an object code. However, the conversion of a remainder loop process to SIMD instructions may be performed in any phase in a compiling process. For example, when an intermediate code is generated, a remainder loop process may be converted to a code of SIMD instructions.

In the above description of the second embodiment, it is assumed by way of example that the SIMD element length is fixed. However, the SIMD element length may be variable. In the second embodiment described above, the load instruction with mask is used. However, there may be a processor that does not support the load instruction with mask. In a case where compiling is performed for use by a processor that does not support the load instruction with mask, instead of the load instruction with mask, it may be allowed to use a load instruction that does not result in an occurrence of an interrupt when an invalid area is accessed. The load instruction that does not result in an occurrence of an interruption when an invalid area is accessed is also used in a prefetch instruction which has a high probability that an invalid area is accessed, and thus many processors support this type of load instruction.

In the second embodiment described above, a plurality of elements operated on in a loop process are converted to SIMD instructions in the ascending operation order. Alternatively, elements may be converted in the descending operation order.

In the above description of the second embodiment, it has been assumed by way of example that one remainder loop process in a source program is converted to a SIMD instruction. However, there is a possibility that the source program includes a plurality of loop processes that result in an occurrence of a remainder loop process. In this case, the conversion to SIMD instructions including instructions for treating a remainder loop process may be performed for each loop process. By converting many remainder loops to SIMD instructions, a resultant executable program provides an improved processing efficiency.

In the above description of the second embodiment, it has been assumed by way of example that the loop has a one-layer hierarchical structure. However, the conversion to SIMD instructions on remainder loops is also possible for a case in which the loop has a multiple-level hierarchical structure. In the first and second embodiments described above, by way of example, SIMD instructions are used. Alternatively, it may be allowed to use a Very Long Instruction Word (VLIW) instruction including a plurality of combinations of an instruction and an element which is an operant to be operated on.

The embodiments have been described above to illustrate examples. Note that components or units in the configurations of these examples may be replaced with other components or units having equivalent or similar functions. An arbitrary component or unit or processing step may be added. Arbitrary two or more configurations (features) of the embodiments described above may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A code generation apparatus comprising:
a memory configured to store a first program including a loop process that performs a same operation on each of a plurality of operation elements set in an array; and
a processor configured to execute a process of generating a second program according to the first program, the second program including:
a first process in which an operation according to a first operation instruction is performed on operation elements iteratively such that each iteration is performed on as operation elements as a number of operand elements, the operation element being extracted from the array in an order for starting from a top element of the array, the iteration being performed as times as a number specified by a quotient obtained as a result of an integer division of a total number of operation elements by the number of operand elements for indicating a unit number of operation elements operated on by one operation instruction;
a second process in which a mask bit string including as mask bits as the number of operand elements is set such that a first mask bits included in the mask bit string and including as mask bits as a remainder of the division are each set to a value for indicating truth, while one or more second mask bits included in the mask bit string other than the first mask bits are each set to a value for indicating false; and
a third process in which the operation is performed on as respective elements as the number of operand elements according to second operation instruction, the elements including one or more remainder operation elements not subjected to the operation in the first process and one or more non-operation elements excluded from being operated on as the number of operand elements, the operation according to the second operation instruction being performed such that each remainder operation element is assigned one of the first mask bits, each non-operation element is assigned one of second mask bits, a result of the operation for an element assigned a truth mask bit is output, and a result of the operation for an element assigned a false mask bit is not output.

2. The code generation apparatus according to claim 1, wherein the second operation instruction includes a load instruction to load the plurality of operation elements into a first register, a third operation instruction to perform the operation on each of the elements loaded in the first register and store a result of the operation into a second register, and a store instruction to write a result of the operation for an element assigned truth in the corresponding mask bit and not to write a result of the operation for an element assigned false in the corresponding mask bit.

3. The code generation apparatus according to claim 2, wherein the load instruction is an instruction to load an element corresponding to a mask bit having a value of truth into the first register and not to load an element corresponding to a mask bit having a value of false.

4. A code generation method comprising generating, by a computer, a second program including:
acquiring a first program including a loop process that performs a same operation on each of a plurality of operation elements set in an array; and
generating a second program according to the first program, the second program including:
a first process in which an operation according to a first operation instruction is performed on operation elements iteratively such that each iteration is performed on as operation elements as a number of operand elements, the operation element being extracted from the array in the order for starting from a top element of the array, the iteration being performed as times as a number specified by a quotient obtained as a result of an integer division of a total number of operation elements by the number of operand elements for indicating a unit number of operation elements operated on by one operation instruction;
a second process in which a mask bit string including as mask bits as the number of operand elements is set such that a first mask bits included in the mask bit string and including as mask bits as a remainder of the division are each set to a value for indicating truth, while one or more second mask bits included in the mask bit string other than the first mask bits are each set to a value for indicating false; and
a third process in which the operation is performed on as respective elements as the number of operand elements according to second operation instruction, the elements including one or more remainder operation elements not subjected to the operation in the first process and one or more non-operation elements excluded from being operated on as the number of operand elements, the operation according to the second operation instruction being performed such that each remainder operation element is assigned one of the first mask bits, each non-operation element is assigned one of second mask bits, a result of the operation for an element assigned a truth mask bit is output, and a result of the operation for an element assigned a false mask bit is not output.

5. A non-transitory, computer-readable recording medium having stored therein a program for causing a computer to execute a process, the process comprising:
acquiring a first program including a loop process that performs a same operation on each of a plurality of operation elements set in an array; and
generating a second program according to the first program, the second program including:
a first process in which an operation according to a first operation instruction is performed on operation elements iteratively such that each iteration is performed on as operation elements as a number of operand elements, the operation element being extracted from the array in the order for starting from a top element of the array, the iteration being performed as times as a number specified by a quotient obtained as a result of an integer division of a total number of operation elements by the number of operand elements for indicating a unit number of operation elements operated on by one operation instruction;
a second process in which a mask bit string including as mask bits as the number of operand elements is set such that a first mask bits included in the mask bit string and including as mask bits as a remainder of the division are each set to a value for indicating truth, while one or more second mask bits included in the mask bit string other than the first mask bits are each set to a value for indicating false; and
a third process in which the operation is performed on as respective elements as the number of operand elements according to second operation instruction, the elements including one or more remainder operation elements not subjected to the operation in the first process and one or more non-operation elements excluded from being operated on as the number of operand elements, the operation according to the second operation instruction being performed such that each remainder operation element is assigned one of the first mask bits, each non-operation element is assigned one of second mask bits, a result of the operation for an element assigned a truth mask bit is output, and a result of the operation for an element assigned a false mask bit is not output.
